(19) United States
(12) Patent Application Publication
(10) Pub. No.: US 2023/0204458 A1
(43) Pub. Date: Jun. 29, 2023

(54) SYSTEM AND METHOD FOR DETERMINING BEARING PRELOAD BY FREQUENCY MEASUREMENT

(71) Applicant: Aktiebolaget SKF, Goteborg (SE)

(72) Inventors: John Cardwell, III, Harleysville, PA (US); Martin D. Rhodus, Camden, SC (US)

(21) Appl. No.: 17/562,102

(22) Filed: Dec. 27, 2021

(51) Int. Cl. G01M 13/04; G01L 1/24

(52) U.S. Cl. CPC G01M 13/04; G01L 1/24; F16C 2233/00

(57) ABSTRACT

A method of determining bearing preload by frequency measurement, the method including the steps of: providing a machine assembly including a bearing, a plurality of sensors in communication with the machine assembly, and a processor in communication with the plurality of sensors, measuring the following related frequencies of the machine assembly including the bearing with the processor; a noise floor energy, a broadband energy, enveloping harmonics, and an overall vibration energy, obtaining a numerical relationship by spectral analysis for each of the related frequencies and storing them into a memory, comparing the numerical relationship stored in memory for each of the related frequencies to a predetermined baseline value. A match between the numerical relationship for each of the stored frequency and the predetermined baseline value indicates a correct preload has been determined. Also, a system for carrying out the method.

### TECHNOLOGICAL FIELD

This invention relates to a system and method of determining bearing preload by frequency measurement. More particularly, this invention relates to a system and method of determining bearing preload by frequency measurement that includes an assembly including a bearing having an inner ring, an outer ring, and a plurality of rolling elements mounted to a machine

### BACKGROUND OF THE INVENTION

Measuring preload in large bearings during manufacture can be difficult. Measuring the preload state of many bearing sizes and styles during operation can also be difficult. The main reason for wanting to be in a preload state is to prevent rolling elements skidding and sliding and therefore damage to the raceways in operation. Having the ability to detect a looseness or non-preloaded state benefits bearing life.

Therefore, a lack of looseness (Radial Internal Clearance) can be detrimental to some Bearing designs and systems leading to a thermal runaway condition. Looseness in manufacture of bearings that are difficult to measure pre-load had been detected by ear, torque, and lift tests. Larger, thinner cross section bearings are often difficult to get a true physical measurement of clearance or preload due to their relative flexibility.

The ideas of what looseness looks like in bearings exists in the vibration industry as a generality, but these indicators have not been tied together as a tool or technique specifically in a manufacturing or performance viewpoint. Consequently, the present invention provides the ability that enables one to detect a looseness or a clearance state in order to insure reliable bearing performance prior at a manufacturing level.

### SUMMARY OF THE INVENTION

According to a first aspect, an exemplary embodiment relates to a method of determining bearing preload by frequency measurement, the method comprising the steps of: providing a machine assembly including a bearing, a plurality of sensors in communication with the machine assembly, and a processor in communication with the plurality of sensors, measuring the following related frequencies of the machine assembly including the bearing with the processor; a noise floor energy, a broadband energy, enveloping harmonics, and an overall vibration energy, obtaining a numerical relationship by spectral analysis for each of the related frequencies and storing them into a memory, comparing the numerical relationship stored in memory for each of the related frequencies to a predetermined baseline value, wherein a match between the numerical relationship for each of the stored frequency and the predetermined baseline value indicates a correct preload has been determined.

According to a second aspect, a system for determining bearing preload by frequency measurement, the system comprises: a machine assembly including a bearing, a plurality of sensors in communication with the machine assembly, a processor in communication with the plurality of sensors, wherein frequencies of the machine assembly including the bearing are measured with the processor, which include a noise floor energy, a broadband energy, enveloping harmonics, and an overall vibration energy, a numerical relationship for each of the related frequencies is obtained by the processor through spectral analysis, wherein the numerical relationship for each of the related frequencies is compared to a predetermined baseline value by the processor, and wherein a match between the numerical relationship for each of the related frequency and predetermined baseline value indicates a correct preload has been determined by the processor.

### BRIEF DESCRIPTION OF THE DRAWINGS

The present invention and its advantages will be better understood by studying the detailed description of specific embodiments given by way of non-limiting examples and illustrated by the appended drawings on which:

FIG. 1 is a schematic view of a system for determining bearing preload by vibration measurement according to a first embodiment of the present invention;

FIG. 2 is a graph of frequency versus amplitude according to the system of FIG. 1; and

FIG. 3 shows the method steps for carrying out the function of the system according to the embodiment of FIG. 1.

### DETAILED DESCRIPTION OF THE INVENTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims.

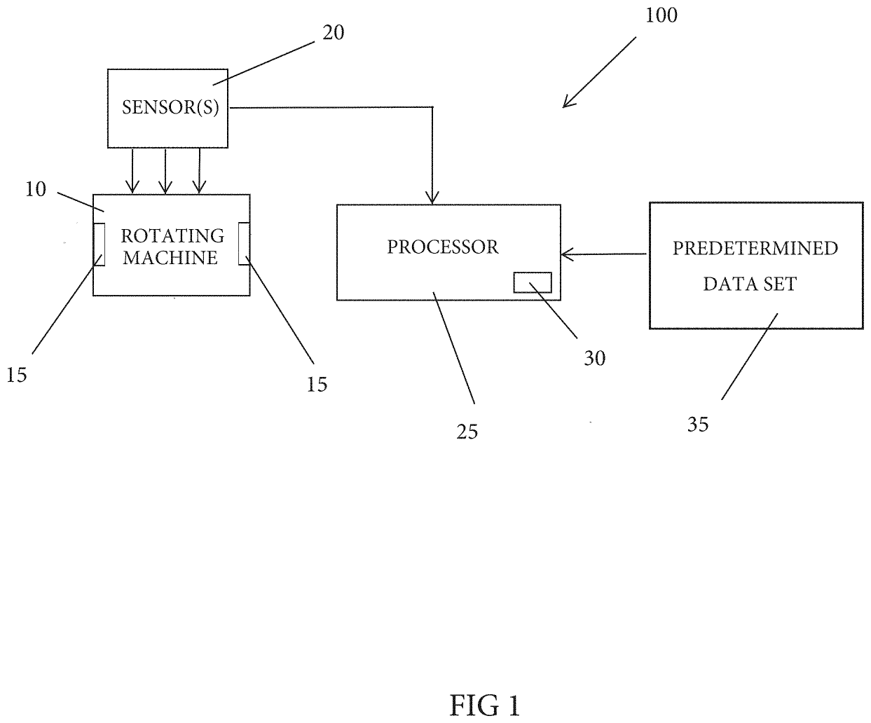

For purposes of description herein, the terms “inward,” “outward,” “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise. SYSTEM

A system 100 for determining bearing preload by frequency measurement is illustrated in FIG. 1. The system 100 provides a rotating machine assembly 10 that provides a bearing 15. Here, the rotating machine assembly 10 is a simple motor assembly 10 that includes two bearings 15. In addition, the system provides at least one sensor 20 that is communication with the rotating machine assembly 10. The at least one sensor may provide one of a laser vibrometer, an accelerometer and/or a coil vibrometer.

The system 100 also provides a processor 25 that is in communication with the at least one sensor 20. Data comprising the frequencies or vibrational energy of the rotating machine assembly 10 including the at least one bearing 15 are communicated to the processor 25. Here, the vibrational energy is measured, and the values are stored in a memory 30 within the processor 25.

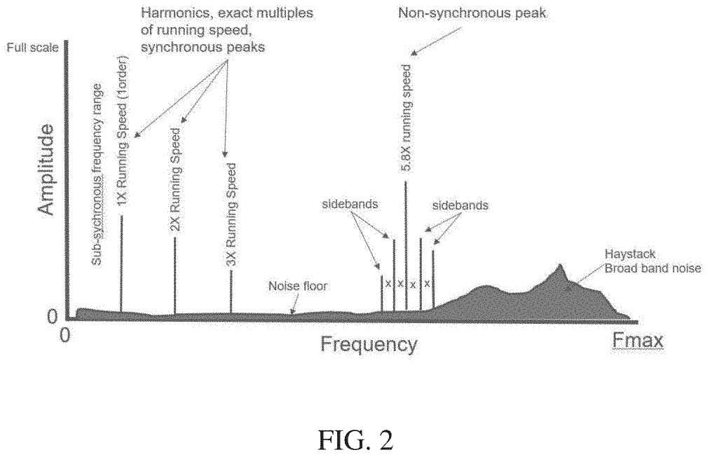

The vibrational energy that is contemplated by the present invention may include a noise floor energy, a broadband energy (Haystack), enveloping harmonics, and an overall vibration energy. See also FIG. 2 that illustrates a graph of frequency versus amplitude according to the system. A numerical relationship for each of the frequencies is obtained by the processor through spectral analysis. Each of the numerical relationships are stored within a memory 30 contained within the processor 25.

The numerical relationship for each of the frequencies stored in the memory 30 is compared to a predetermined baseline data set 35 by the processor. The predetermined baseline data set is determined in two ways. First, by physically measuring looseness and second, with vibration tests on a bearing with an ideal known looseness state.

The preload amount by considering the amplitude of bearing and rotating speed peaks in both regular spectra and demodulated spectra are quantified. The frequencies or bands of frequencies based on machine running speed, bearing geometry and machine structure and response are measured to determine the peaks desired to be compared.

In particular, the following criteria about the peaks to be compared with respect to the rotating machine 10 may be obtained:

The numerical relationships for desired harmonic peaks at 1 times running speed or first order,

The numerical relationships for desired peaks at exact multiples of running speed,

The numerical relationships for desired peaks at 3 times running speed or synchronous peak,

The numerical relationships for running speed for desired non-synchronous peaks, and

The numerical relationships for running speeds at multiples of running speed may.

Consequently, a match between the numerical relationship for each of the frequencies and the predetermined baseline data set value indicates a correct preload has been determined by the processor.

### Method

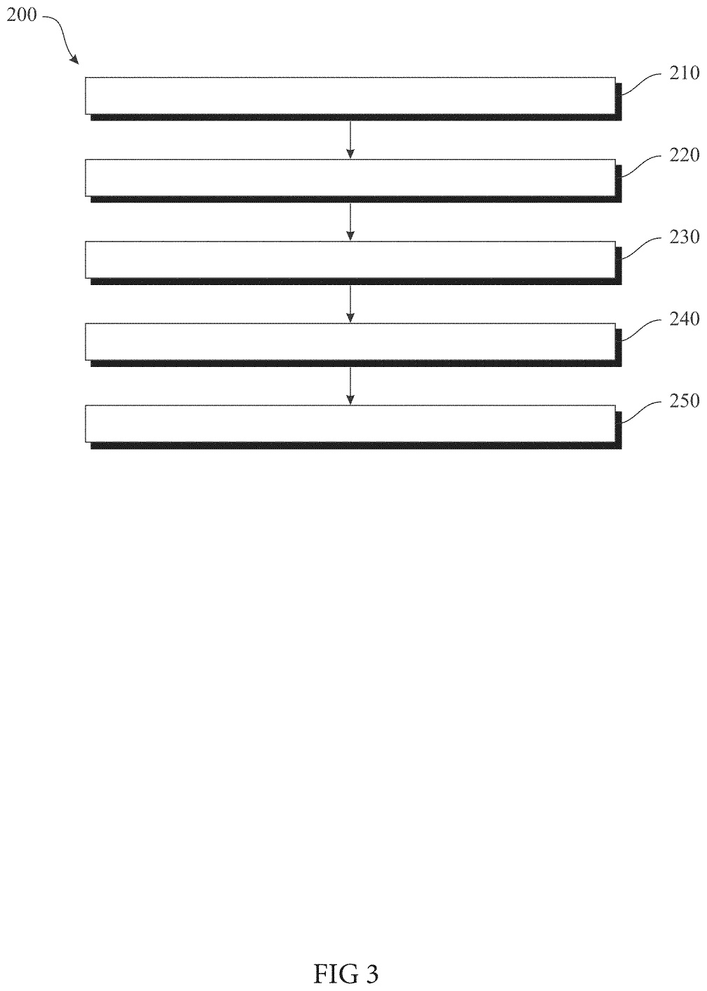

A method 200 for determining bearing preload by frequency measurement is illustrated in FIG. 3.

In a first step 210, the method comprises providing a machine assembly including a bearing, a plurality of sensors in communication with the machine assembly, and a processor in communication with the plurality of sensor.

In a second step 220, the method comprises measuring the following related frequencies of the machine assembly including the bearing with the processor; a noise floor energy, a broadband energy, enveloping harmonics, and an overall vibration energy. Here, the frequencies or bands of frequencies are measured based on machine running speed, bearing geometry and machine structure and response to determine the peaks desired to be compared.

In a third step 230, the method provides obtaining a numerical relationship for each of the related frequencies. Here, the frequencies are transformed into spectral data.

In a fourth step 240, the method provides comparing the numerical relationship for each of the related frequencies to a predetermined baseline value. The predetermined baseline values may be identified by physically measuring looseness or with vibration tests on a bearing with an ideal known looseness state.

In a fifth step 250, the method provides determining a correct preload by identifying a match between the numerical relationship for each of the related frequency and the predetermined baseline value. Here, the preload amount quantified by considering the amplitude of bearing and rotating speed peaks in both regular spectra and demodulated spectra.

Since many modifications, variations, and changes in detail can be made to the described preferred embodiments and methods of the invention, it is intended that all matters in the foregoing description and shown in the accompanying drawings be interpreted as illustrative and not in a limiting sense. Thus, the scope of the invention should be determined by the appended claims and their legal equivalence.

The present invention may be a system, a method, and/or a computer program product at any possible technical detail level of integration. The computer program product may include a computer readable storage medium (or media) having computer readable program instructions thereon for causing a processor to carry out aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved.

It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In addition, the terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The descriptions of the various embodiments herein have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1) A method of determining bearing preload by frequency measurement, the method comprising the steps of:
providing a machine assembly including a bearing, a plurality of sensors in communication with the machine assembly, and a processor in communication with the plurality of sensors,
measuring the following related frequencies of the machine assembly including the bearing with the processor;
a noise floor energy,
a broadband energy,
enveloping harmonics, and
an overall vibration energy,
obtaining a numerical relationship by spectral analysis for each of the related frequencies and storing them into a memory,
comparing the numerical relationship stored in memory for each of the related frequencies to a predetermined baseline value, wherein
a match between the numerical relationship for each of the stored frequency and the predetermined baseline value indicates a correct preload has been determined.

2) The method according to claim 1, further comprising determining the predetermined baseline value by physically measuring looseness or with vibration tests on a bearing with an ideal known looseness state.

3) The method according to claim 1, further comprising measuring the frequencies or bands of frequencies based on machine running speed, bearing geometry and machine structure and response to determine the peaks desired to be compared.

4) The method according to claim 3, further comprising obtaining numerical relationships for desired harmonic peaks at 1 times running speed or first order.

5) The method according to claim 3, further comprising obtaining numerical relationships for desired peaks at exact multiples of running speed.

6) The method according to claim 3, further comprising obtaining numerical relationships for desired peaks at 3 times running speed or synchronous peak.

7) The method according to claim 3, further comprising obtaining numerical relationships for running speed for desired non-synchronous peaks.

8) The method according to claim 7, further comprising obtaining numerical relationships for running speeds at multiples of running speed.

9) The method according to claim 3, further comprising quantifying the preload amount by considering the amplitude of bearing and rotating speed peaks in both regular spectra and demodulated spectra.

10. A system for determining bearing preload by frequency measurement, the system comprises:
a machine assembly including a bearing,
a plurality of sensors in communication with the machine assembly,
a processor in communication with the plurality of sensors, wherein
frequencies of the machine assembly including the bearing are measured with the processor, which include a noise floor energy, a broadband energy, enveloping harmonics, and an overall vibration energy,
a numerical relationship for each of the related frequencies is obtained by the processor through spectral analysis, wherein
the numerical relationship for each of the related frequencies is compared to a predetermined baseline value by the processor, and wherein a match between the numerical relationship for each of the related frequency and predetermined baseline value indicates a correct preload has been determined by the processor.

11) The system according to claim 10, wherein the sensor is at least one of a laser vibrometer, an accelerometer and/or a coil vibrometer.

12) The system according to claim 1, wherein the predetermined baseline value is determined by physically measuring looseness or with vibration tests on a bearing with an ideal known looseness state.

13) The system according to claim 1, wherein the frequencies or bands of frequencies based on machine running speed, bearing geometry and machine structure and response are measured to determine the peaks desired to be compared.

14) The system according to claim 3, wherein relationships for desired harmonic peaks at 1 times running speed or first order are obtained.

15) The system according to claim 3, wherein numerical relationships for desired peaks at exact multiples of running speed are obtained.

16) The system according to claim 3, wherein numerical relationships for desired peaks at 3 times running speed or synchronous peak are obtained.

17) The system according to claim 3, wherein numerical relationships for running speed for desired non-synchronous peaks are obtained.

18) The system according to claim 7, wherein numerical relationships for running speeds at multiples of running speed are obtained.

19) The system according to claim 3, wherein the preload amount by considering the amplitude of bearing and rotating speed peaks in both regular spectra and demodulated spectra are quantified.
